(19) United States
(12) Patent Application Publication
(10) Pub. No.: US 2011/0017828 A1
(43) Pub. Date: Jan. 27, 2011

(54) HANDHELD OPTICAL IMAGING DEVICE AND METHOD

(75) Inventor: Jeffrey A. Pine, Auburn, NY (US)

Correspondence Address: BOND, SCHOENECK & KING, PLLC, ONE LINCOLN CENTER, SYRACUSE, NY, 13202-1355, US

(73) Assignee: JADAK, LLC, North Syracuse, NY (US)

(21) Appl. No.: 12/508,689

(22) Filed: Jul. 24, 2009

(51) Int. Cl. G06K 7/10

(52) U.S. Cl. 235/472.01; 235/462.45

(57) ABSTRACT

A handheld optical imaging reader having a body specifically configured to be held in the hand and improve the ease by which a user can effectively obtain information from target objects presented to the reader. The body of the reader extends along a first axis and includes an optical imager aligned along a non-parallel second axis and a display extending along a non-parallel plane. The reader includes two triggers mounted to opposing sides of the body and positioned for activation by the thumb of a user when held in either the left of right hand using either an overhand or underhand grip. The reader may include a display and keypad to allow for high-level user functions and interaction.

### BACKGROUND OF THE INVENTION

1. Field of the Invention

The present invention relates to coded record systems and, more particularly, to readers having camera-type readers for barcode and image processing.

2. Description of the Related Art

Machine vision plays an important role in automated and robotic systems, such as assembly line manufacturing, quality control inspection, and sample processing. Conventional systems are generally comprised of an optical imager, such as a charged coupled device (CCD) or similar device using digital imaging technology, that is positioned capture images of objects that pass in front of it. In low-light or enclosed applications, machine vision systems may include an illumination source, such as a bank of light emitting diodes (LEDs), positioned proximately to the imager. The images are subsequently processed to decode information contained in the resulting two-dimensional image, such as 1D linear codes, 2D stacked/matrix codes, OCR fonts, and postal codes. The image captured by the machine vision system may also be subjected to more advanced processing, such as shape recognition or detection algorithms, that provide information about the object of interest in the image.

In the health care industries, barcode and other symbolic data encoding systems are being used to track information, control work flow, and ensure security and safety in the workplace. In older systems, relevant information was encoded into barcodes, which are essentially graphic representation of data (alpha, numeric, or both). Barcodes encode numbers and letters into different types of linear codes, two-dimensional codes, and composite codes (a combination of linear and two-dimensional codes) that are scanned by laser based device and then interpreted to reveal the encoded information. In more recent applications, referred to as digital or optical image capture, an optical device captures a digital picture of the barcode and software in the imager orients the picture and decodes the barcode contained in the picture.

Conventional barcode readers and imaging systems are not well suited for use in the health care industry as they are adapted for manufacturing or commercial applications where ergonomics and ease of use are not a consideration. For example, such systems are generally bulky handheld units having a full grip handle and trigger assembly coupled to a large reader. These systems are also not readily used in medical applications as they are not compatible with medical cleaning solvents and solutions, or easily sterilized by medical workers. In addition, such systems are often lack the performance and ability to scan barcodes and other icons that become damaged.

### BRIEF SUMMARY OF THE INVENTION

It is therefore a principal object and advantage of the present invention to provide a handheld optical imager that is designed for use in the health care industry.

It is therefore a principal object and advantage of the present invention to provide a handheld optical imager that is ergonomic.

It is therefore a principal object and advantage of the present invention to provide a handheld optical imager that is easy to use.

It is therefore a principal object and advantage of the present invention to provide a handheld optical imager that is durable enough for medical application.

Other objects and advantages will in part be obvious, and in part appear hereinafter.

In accordance with the foregoing objects and advantages, the present invention provides a handheld optical imaging reader having a body specifically configured to be held in the hand and improve the ease by which a user can effectively obtain information from target objects presented to the reader. More specifically, the body of the reader extends along a first axis and includes an optical imager aligned along a non-parallel second axis and a display extending along a non-parallel plane. The reader further includes two triggers mounted to opposing sides of the body and positioned for activation by the thumb of a user when held in either the left of right hand using either an overhand or underhand grip. In this manner, a user may capture images of a target that is not readily accessible by conventional scanners, such as a patient wristband, that is routinely positioned in an awkward to reach location. In one embodiment, the reader includes a display and keypad to allow for high level user functions and interaction. In a second embodiment, reader includes only a single trigger mounted to an upper surface of the body, thereby significantly reducing the profile of the reader.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of a first embodiment of a handheld reader according to the present invention.

FIG. 2 is a top view of a first embodiment of a handheld reader according to the present invention.

FIG. 3 is an end view of a first embodiment of a handheld reader according to the present invention.

FIG. 4 is a side view of a first embodiment of a handheld reader according to the present invention.

FIG. 5 is a high-level schematic of the internal components of a first embodiment of a reader according to the present invention.

FIG. 6 is a perspective view of a second embodiment of a handheld reader according to the present invention.

FIG. 7 is a side view of a second embodiment of a handheld reader according to the present invention.

### DETAILED DESCRIPTION OF THE INVENTION

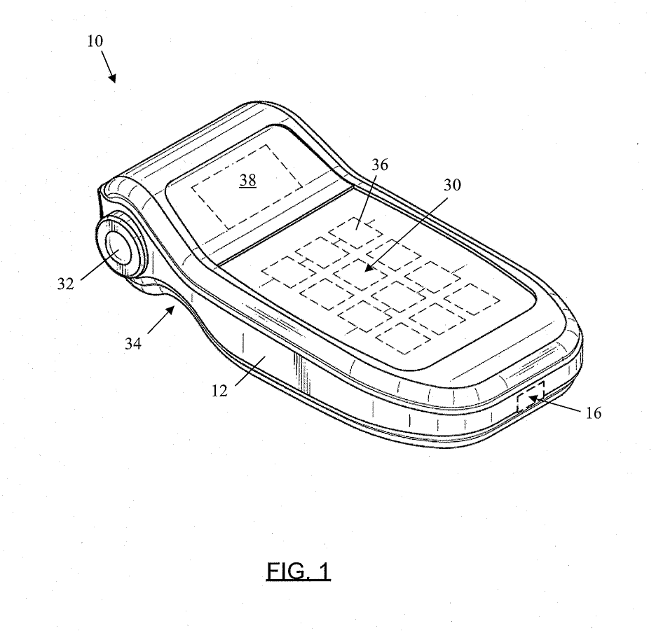

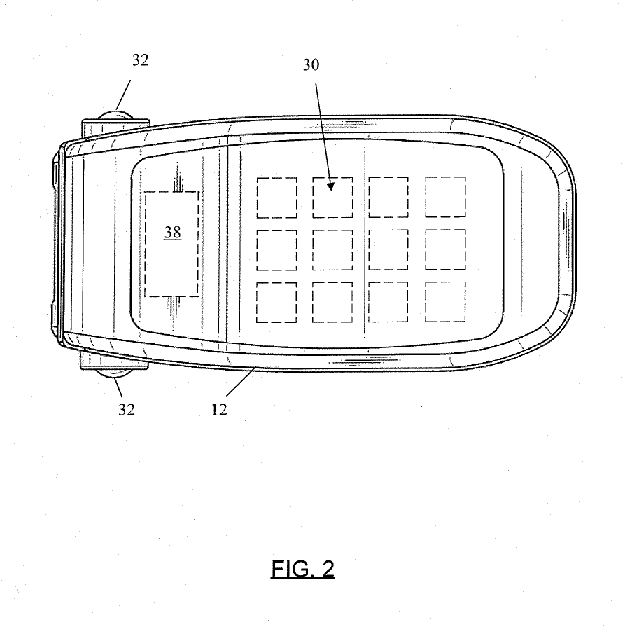

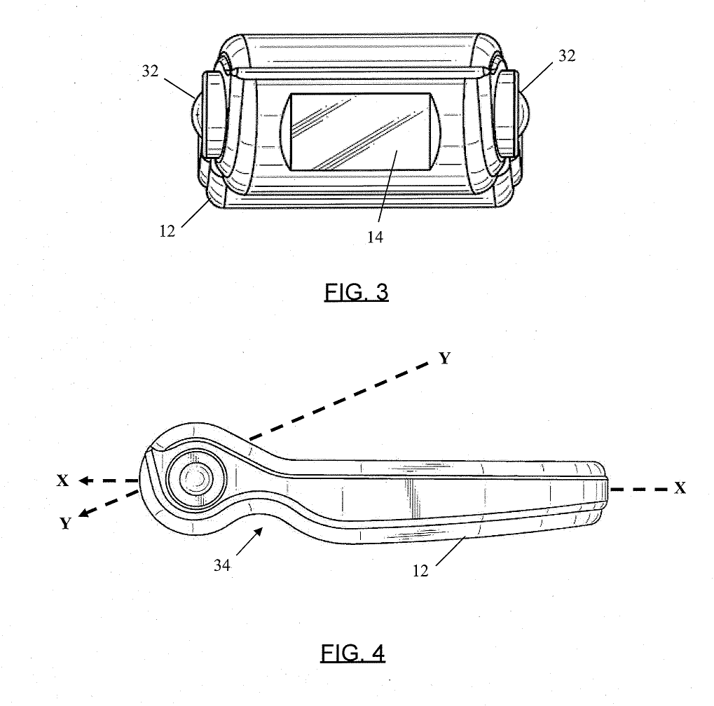

Referring now to the drawings, wherein like reference numerals refer to like parts throughout, there is seen in FIGS. 1 through 3 a handheld reader 10 according to the present invention. Reader 10 generally comprises a housing 12 extending along longitudinal axis X-X from an imager window 14 at the front of the reader to a host interface 16 at the rear of the reader. Housing 12 is configured to be grasped by the hand of a user and, as will be described in more detail hereinafter, is arranged to provide improved ergonomics and ease of use. Housing 12 is preferably manufactured from chemical resistant plastic or silicone rubber. Window 14 preferably comprises a durable filter material for protection, such as Clarex®, available from Astra Products, Inc. of Baldwin, N.Y. In addition, any seams used to form housing 12 from multiple subparts should be tightly sealed against the ingress of fluids.

In a preferred embodiment, housing 12 should be manufactured to comply with IP54 as defined in International Standard IEC 60529 for the manufacture of solid objects. Accordingly, reader 10 may be cleaned with a ten percent bleach solution, a pure ammonia solution, isopropyl alcohol, or commercially available cleaners, such as Citrace® and Dispatch ®, available from Caltech Industries, Inc. of Midland, Mich., and CaviCide®, available from Metrex International of Orange, Calif.

Referring to FIG. 4, host interface 16 may comprise a conventional RS232 transceiver and associated 12 pin FFC jack. Alternatively, interface 16 may comprise other conventional buses, such as USB, IEEE, 1394, IrDA, PCMCIA, or Ethernet (TCP/IP). Interface 16 may also comprise a wireless transceiver for wireless communication to a host computer and is programmed with the applicable protocols for interfacing with a host computer, such as Bluetooth(r) or 802.11 protocols. It should be recognized by those of skill in the art that interface 16 may be provided as part of a permanently tethered cable arrangement, a releasable tether, such as with a USB connection, or a completely wireless arrangement. Host interface 16 thus provides a communications link between reader 10 and a host device, and may optionally provide structural support and, as discussed below, a power supply.

Reader 10 includes an optical imager 18 positioned therein to capture images of a target through window 14. In a preferred embodiment, imager 18 and window 14 are positioned to capture images along an axis Y-Y that is non-parallel with respect to axis X-X. For example, axis Y-Y may be offset downwardly from axis X-X by approximately fifteen degrees.

Imager 18 may comprise any off-the-shelf optical imager capable of capturing digital images of a target that may be further processed for barcode and/or shape recognition. For example, Honeywell Imaging and Mobility of Skaneateles Falls, N.Y. sells a 5×80 series of imagers are capable of scanning and decoding most standard barcodes including linear, stacked linear, matrix, OCR, and postal codes. Other acceptable optical imaging platforms may also include the EV12, EV15, EA15, and XA21 imagers available from Intermec Technologies Corporation of Everett, Wash., or any custom imaging packaging sold commercially for incorporation into machine vision or optical imaging systems. It should be recognized by those of skill in the art that the particular model or make optical imaging platforms that may be interfaced with the present invention are not important. It should further be recognized that the present invention may be used with other data collection devices, such as laser scanners, RFID transceivers, and the like.

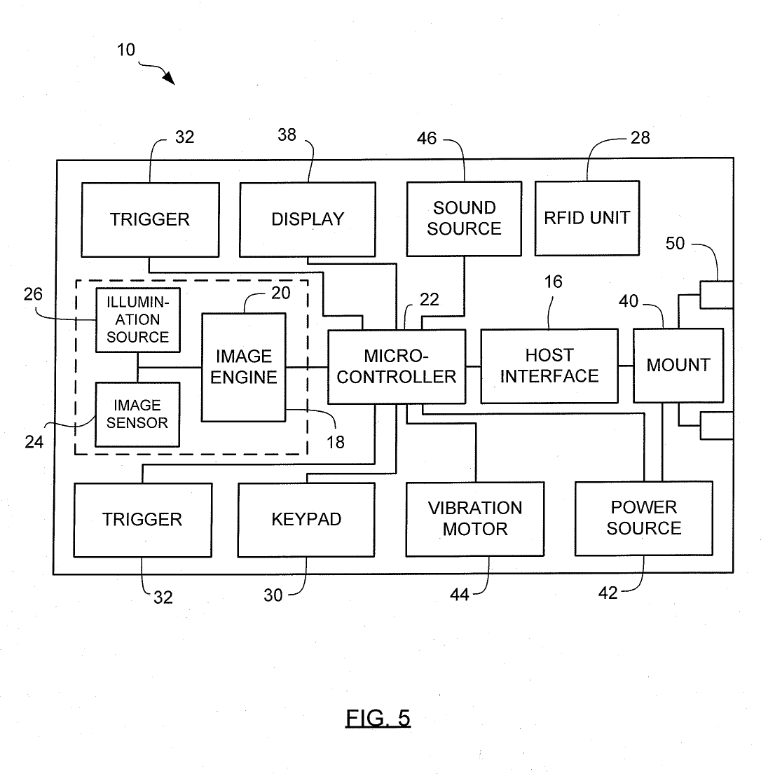

Imager 18 preferably comprises an image engine 20 having image processing circuitry for omni-directional optical scanning. Referring to FIG. 5, imager 18 may further be interconnected to a microcontroller 22 for managing imaging and illumination operations, performing processing of captured images, and communicating through a host, such as a host computer or medical device, through a host interface 16. Image engine 20 controls an image sensor 24, such as a complementary metal oxide semiconductor (CMOS) image sensor, and is capable of capturing two-dimensional images of 1D linear barcodes, 2D stacked/matrix barcodes, standard optical character recognition (OCR) fonts, Reduced Space Symbology (RSS) barcodes, and postal barcodes, as well as providing image captured images for use in a wide range of applications, such as image and shape recognition, signature capture, image capture, and non-standard optical character recognition. Imager 18 may further include an integrated illumination source 26 connected to engine 20, such as one or more light emitting diodes (LEDs) of various wavelengths, to enhance illumination, operation, and image capture. For example, imager 18 may include red LEDs for general illumination and green LEDs for targeting.

Imager 18 obtains an optical image of the field of view and, using preprogrammed algorithms in image engine 20, deciphers the context of the image to determine the presence of any decodable barcodes, linear codes, matrix codes, and the like. Image engine 20 may be programmed to perform other image processing algorithms on the image captured by imager 18, such as shape recognition, match filtering, statistical analysis (e.g., threshold detection), and other high-level processing techniques.

Reader 10 may optionally include RFID unit 28 including an RFID transceiver and associated antenna supporting standard RFID protocols, such as the TI Tag-it transponder protocol or ISO 15693. For these protocols, transceiver operates at 13.56 MHz, and may comprise a S6700 Multi-Protocol Transceiver IC available from Texas Instruments of Dallas, Tex. Depending on the application, other frequency transceivers may be more appropriate based on target range, power availability, cost, etc. RFID unit 28 may further be interconnected to sound source 46 or display 38 either directly or indirectly through microcontroller 22 for indicating a successful or unsuccessful interrogation of an RFID tag.

In one preferred embodiment of the present invention, of reader 10 includes a keypad 30 positioned on the top surface of housing 12, a pair of opposing triggers 32 positioned on opposing sides of housing 12 for triggering optical imaging operations, and an integral finger rest 34 formed into the bottom surface of housing 12. Opposing triggers 32 allow for easier activation using the thumbs when a user is holding the device in the palm of the left or right hand. Keypad 30 preferably comprises a membrane-style arrangement, thereby allowing for easier disinfection and cleaning of reader 10 without allowing fluids to infiltrate the internal components of reader 10. Keypad may optionally include a dedicated button 36 for triggering optical imaging operations.

A display 38 may optionally be provided on the top surface of housing 12 in proximity to keyboard 30. Display 38 may be used to provide a user with general information, such as the time of day and date, as well as device status information, such as an indication that a barcode was successfully scanned and the amount of battery life remaining, and application specific information, such as the name of the patient wearing a bracelet containing the barcode that was successfully scanned. Microcontroller 22 is preferably programmed to control display 38 and provide the appropriate visual information during use of reader 10. To assist with the viewing of information during operation of reader 10, display 38 may be positioned along a plane that is non-parallel with respect to axis X-X, such as axis Y-Y discussed previously. In a preferred embodiment, display 38 may be offset approximately sixteen degrees.

Host interface 16 may optically include a mount 40 for interconnection to a cradle (not shown) associated with a host device. In addition to providing structural interconnection to a separate device, mount 40 may further comprise one or more contacts 50 for establishing electrical continuity with reader 10, particular when reader 10 is provided with an onboard power source 42, such as a rechargeable and/or replaceable battery. It should be recognized by those of skill in the art that interface 16 could include a USB port to provide a structural attachment, a communications link, and a power source or recharge connection. Alternatively, interface 16 could additionally include wireless communication capabilities, while provided only power through physical contact between interface 16 and an external device.

For operations with an on-board power source 42 such as a battery, microcontroller 22 is preferably programmed to implement a number of power modes to address operational needs while preserving battery life. For example, microcontroller 22 may direct placement of reader 10 into a fully awake mode, where all operations are powered, a dozing mode, where a more limited list of processes remain powered, and a sleep mode, where only essential processes are powered. For example, dozing mode may maintain power to display 38 and basic operations, and sleep mode involves placement of all peripherals into the lowest possible power state, such as display 38, image engine 18, and any wireless version of interface 16. When any trigger 32 or keypad button, including button trigger 36 are activated, reader 10 returns to a fully awake mode.

Reader 10 may further comprise a vibration motor 44 interconnected to microcontroller 22. In this case, microcontroller 22 may be programmed to actuate vibration motor 44 in response to various conditions to provide a tactile response to a user. For example, vibration may be used to alert a user to successful or unsuccessful operation of reader 10. This feature is particular useful in the medical field, where a user may not be able to easily view display 38, such as when reaching around or over an obstacle to capture an image of a barcode on a patient wristband. Reader 10 may further or optionally include a sound source 46, such as a buzzer or speaker, for providing audible feedback to a user. For example, microcontroller 22 may be programmed to provide audible tones may be used to indicate successful or unsuccessful barcode reading operations, or to indicate when a wireless reader 10 has been carried out of range of the wireless host.

Reader 10 may further comprise a magnet 48 secured to or provided as part of housing 12 for readily attaching reader 10 to any magnetizable surface. For example, reader 10 may be attached to a file cabinet or other metal surface to prevent against loss or misplacement. Magnet 48 may also be used to secure reader 10 in a designated cradle associated with a host device.

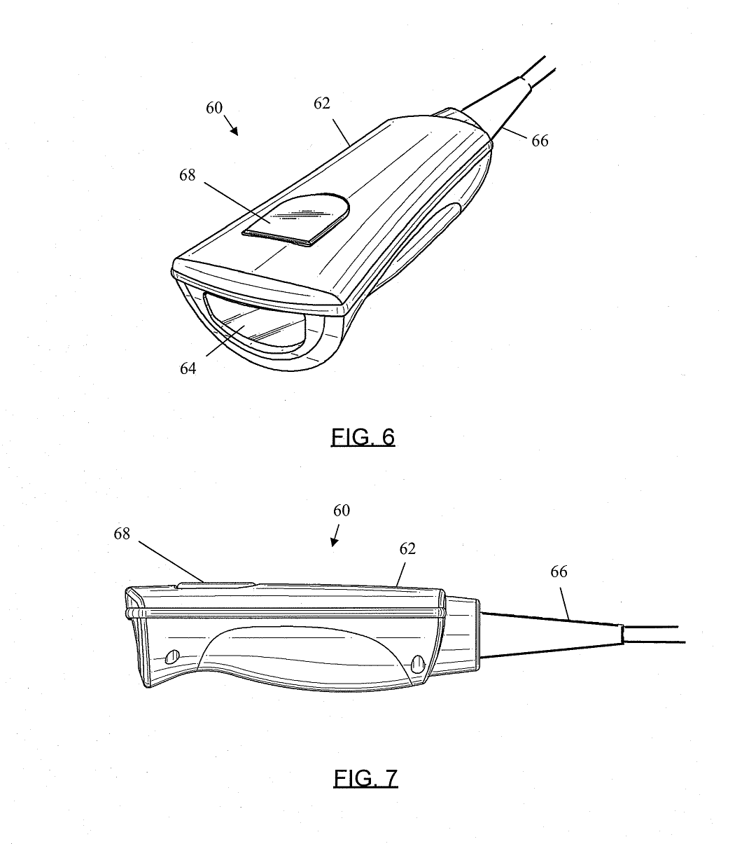

There is seen in FIGS. 6 and 7 another embodiment of the present invention. More specifically, handheld reader 60 is configured to have a reduced profile by the omission of any keypad or display. Reader 60 comprises a housing 62 extending along a longitudinal axis from a imaging window 64 at the front to a rear tether 66. Reader 10 includes a single trigger 68 positioned along the upper surface of housing 62. As explained above, imaging window 64 (and the internal imager) may be aligned to capture images along an axis that is non-parallel with respect to the longitudinal axis of reader 60.

Tether 66 may provide for structural, communicative, and electrical interconnection to a host or other device. For example, tether 66 may include cabling for two-way communications between reader 10 and host device. Alternatively, tether 66 may simply comprise a lanyard or cord so reader 60 can hang loosely around the neck of a user. In this case, tether 66 may be interconnected to a trigger internal to tether 66 that is operated by tugging on tether 66 while holding housing 62 in place and directing window 64 at a target, thereby prompting barcode or image processing processes to commence while reader is securely maintained around the neck of the user.

What is claimed is:

1. A handheld optical imager reader, comprising:
a housing extending along an axis and including a microcontroller positioned therein;
an optical imager positioned in said housing to capture images of a target presented to said imager, wherein said optical imager is interconnected to said microcontroller for transmitting captured images of said target to said microcontroller; and
first and second triggers positioned on opposing sides of said housing and operatively interconnected to said microcontroller, wherein activation of either of said triggers causes said optical imager to capture an image of said target.

2. The reader of claim 1, further comprising a vibration motor interconnected to said microcontroller, wherein said microcontroller is programmed to activate said vibration motor in response to capturing an image of said target.

3. The reader of claim 2, wherein said microcontroller is programmed to activate said vibration motor when said image includes encoded information that is successfully decoded by said reader.

4. The reader of claim 2, further comprising a user display interconnected to said microcontroller.

5. The reader of claim 4, further comprising a keypad interconnected to said microcontroller.

6. The reader of claim 5, further comprising a speaker interconnected to said microcontroller.

7. The reader of claim 6, further comprising a finger rest formed in said housing and extending between said first and second triggers.

8. The reader of claim 7, wherein said display is positioned perpendicularly to a second axis that extends in non-parallel relation to said axis of said housing.

9. The reader of claim 7, wherein said imager is aligned along a second axis that extends in non-parallel relation to said axis of said housing.

10. The reader of claim 1, wherein said housing is hermitically sealed.

11. The reader of claim 10, wherein said housing is resistant to microbe.

12. A handheld optical imager reader, comprising:
a housing extending substantially linearly along an axis from a first end to a second and including a microcontroller positioned therein;
an optical imager positioned in said housing and aligned along said axis to capture images of a target presented to said imager, wherein said optical imager is interconnected to said microcontroller for transmitting captured images of said target to said microcontroller; and
a trigger positioned on one side of said housing and operatively interconnected to said microcontroller, wherein activation of said triggers causes said optical imager to capture an image of said target; and
a host interface interconnected to said microcontroller; and
a tether extending along said axis from said second end of said housing and containing wiring interconnecting said host interface to a host device.

13. The reader of claim 12, further comprising a vibration motor interconnected to said microcontroller, wherein said microcontroller is programmed to activate said vibration motor in response to capturing an image of said target.

14. The reader of claim 13, wherein said microcontroller is programmed to activate said vibration motor when said image includes encoded information that is successfully decoded by said reader.

15. The reader of claim 14, further comprising a speaker interconnected to said microcontroller.

16. The reader of claim 15, wherein said housing is hermitically sealed.
